(19) United States
(12) Patent Application Publication
(10) Pub. No.: US 2006/0265086 A1
(43) Pub. Date: Nov. 23, 2006

(54) Apparatus and method thereof for actuating object

(76) Inventors: Yen-lin Wang, Kweishan (TW); Sheng-Hsiang Hu, Kweishan (TW); Chun-Ming Shen, Kweishan (TW); Jian-Ming Lee, Kweishan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/416,750

(22) Filed: May 3, 2006

(30) Foreign Application Priority Data
May 19, 2005 (TW) 094116210

(51) Int. Cl. G05B 19/18

(52) U.S. Cl. 700/56

(57) ABSTRACT

The invention discloses an apparatus for actuating an object movably mounted on a slide rail. The apparatus includes a processing unit, a controlling unit, a driving unit, and a motor. The processing unit is used for receiving an input signal and outputting a command signal in response to the input signal. The controlling unit is coupled to the processing unit and used for selectively outputting three kinds of enabling signals. The driving unit is coupled to the controlling unit and used for selectively outputting three kinds of driving signals each of which has a respective duty cycle. The motor is coupled to the driving unit and operatively connected to the object. The motor is used for actuating the object moving along the slide rail in accordance with different driving signal. Accordingly, when the object is reversed from the original moving direction, the apparatus of the invention can also function well.

### BACKGROUND OF THE INVENTION

1. Field of the Invention

The invention relates to an apparatus and the method thereof for actuating an object, and more particularly to an apparatus and the method thereof for fine tuning the movement of the object when the object is reversed from the original moving direction.

2. Description of the Prior Art

In the prior art, the height or the position of a projection lens of a projector can be adjusted by a motor-driven apparatus. Generally speaking, the conventional motor-driven apparatus always utilizes a motor to actuate a gear set and further to drive a screw rod, so as to transform rotation into linear movement. Accordingly, the projection lens is capable of being lifted, lowered, or shifted. In other words, the user can utilize a remote controller or the like to control the motor-driven apparatus, so as to adjust the projected images to a most appropriate position.

For example, a user desires to adjust the position of a projected image. When the user just presses the upward or downward button once, the position of the projected image will also move with a step only. On the other hand, when the user presses the button for a span of time, the position of the projected image will keep moving until the user sets the button free. Accordingly, the user can fast adjust or fine tune the position of the projected image based on his/her own requirement. Furthermore, when the user is fine tuning the position of the projected image, how far the projected image will move is controlled by the duty cycle of voltage signal. When the duty cycle is shorter, the motor will rotate a little, and the accuracy of adjustment will also be raised.

When an engineer designs the mechanical parts, he/she always keeps a gap between two moving parts because of tolerance concern, e.g. the backlash between two gears. The more the moving parts are connected in sequence, the bigger the gap accumulation is. When the user desires to fine tune the position of the projected image, the above-mentioned gap will be a trouble. For example, when the user desires to adjust the position of the projected image upwardly, he may additionally need to reverse the position of the projected image downwardly by a step due to excessive upward adjustment. Ideally, he only needs to press the downward button once. However, because of the gap, the user always needs to further press the downward button once, such that the position of the projected image moves downwardly for a step. Similarly, when the user desires to adjust the position of the projected image downwardly, he may additionally need to reverse the position of the projected image upwardly due to excessive downward adjustment. Then, the same problem mentioned in the above will also occur. In other words, when the user desires to reverse the motor-driven apparatus to adjust the position of the projected image, the first press or other presses for actuating the motor by the user is used to compensate the gap. The smaller the adjustment scale of projected position is, the more times the user needs to press the button to compensate the gap until he/she can fine tune the projected position finally. It's very inconvenient for the user.

Therefore, the objective of the invention is to provide an apparatus and the method thereof for actuating an object, so as to solve the aforementioned problems.

### SUMMARY OF THE INVENTION

An objective of the invention is to provide an apparatus and the method thereof for actuating an object. Based on different input signals, the apparatus can selectively actuate the object moving along a slide rail. More particularly, when the object is reversed from the original moving direction, the apparatus of the invention is capable of accurately adjusting the movement of the object without being influenced by the gap between any two parts.

The apparatus of the invention is used for actuating an object movably mounted on a slide rail. According to a preferred embodiment of the invention, the object can be a projection lens of a projector, and the slide rail is disposed in the projector. The apparatus comprises a processing unit, a controlling unit, a driving unit, and a motor. The processing unit is used for receiving an input signal and outputting a command signal in response to the input signal. The controlling unit is coupled to an output of the processing unit and used for selectively outputting a forwarding-single-step enabling signal, a continuously-forwarding enabling signal, or a reversing-single-step enabling signal in accordance with the command signal. The driving unit is coupled to an output of the controlling unit and used for selectively outputting a first driving signal in response to the forwarding-single-step enabling signal, a second driving signal in response to the continuously-forwarding enabling signal, or a third driving signal in response to the reversing-single-step enabling signal. The first driving signal has a first polarity and a first duty cycle, the second driving signal has the first polarity and a second duty cycle, and the third driving signal has a second polarity opposite to the first polarity and the first duty cycle plus a compensation period. The motor is coupled to an output of the driving unit and operatively connected to the object. The motor is used for actuating the object moving along the slide rail in accordance with the first driving signal, the second driving signal, or the third driving signal. In the above-mentioned embodiment, the first polarity is capable of driving the object moving along a first direction, and the second polarity is capable of driving the object moving along a second direction opposite to the first direction. In other words, when the object moves along the slide rail from the first direction to the second direction, and because the duty cycle of the third driving signal is larger than the duty cycle of the first driving signal, the apparatus of the invention is capable of accurately adjusting the movement of the object without being influenced by the gap between any two parts. Moreover, the aforementioned first direction and second direction both can be designed based on practical application. For example, if the first direction is set as an upward direction, the second direction is set as a downward direction. On the other hand, if the first direction is set as a downward direction, the second direction is set as an upward direction.

The advantage and spirit of the invention may be understood by the following recitations together with the appended drawings.

### BRIEF DESCRIPTION OF THE APPENDED DRAWINGS

FIG. 1 is a functional block diagram illustrating an object actuating apparatus according to a first preferred embodiment of the invention.

FIG. 2 is a schematic diagram illustrating the first driving signal, the second driving signal, and the third driving signal.

FIG. 3 is a flowchart showing the method for actuating the object according to the first preferred embodiment of the invention.

### DETAILED DESCRIPTION OF THE INVENTION

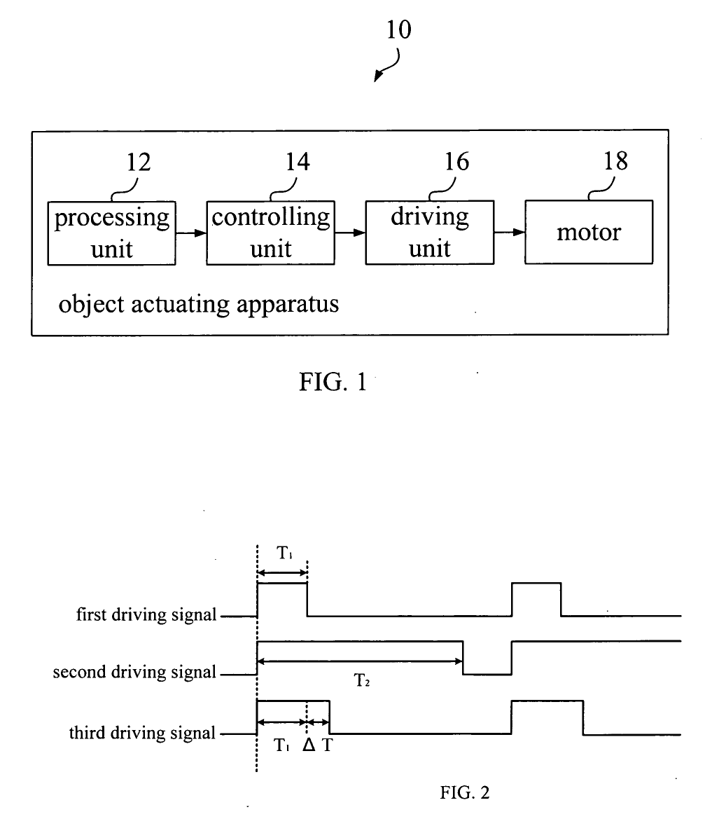

Referring to FIG. 1, FIG. 1 is a functional block diagram illustrating an object actuating apparatus 10 according to a first preferred embodiment of the invention. The apparatus 10 is used for actuating an object (not shown) movably mounted on a slide rail (not shown). The object of the invention can be a projection lens of a projector (not shown), and the slide rail is disposed in the projector. As shown in FIG. 1, the apparatus 10 comprises a processing unit 12, a controlling unit 14, a driving unit 16, and a motor 18. The processing unit 12 is used for receiving an input signal and outputting a command signal in response to the input signal. The controlling unit 14 is coupled to an output of the processing unit 12 and used for selectively outputting a forwarding-single-step enabling signal, a continuously-forwarding enabling signal, or a reversing-single-step enabling signal in accordance with the command signal. The driving unit 16 is coupled to an output of the controlling unit 14 and used for selectively outputting a first driving signal in response to the forwarding-single-step enabling signal, a second driving signal in response to the continuously-forwarding enabling signal, or a third driving signal in response to the reversing-single-step enabling signal. The driving unit 16 can be an integrated circuit. The first driving signal, the second driving signal, or the third driving signal can be a voltage signal, respectively. The motor 18 is coupled to an output of the driving unit 16 and operatively connected to the object. The motor 18 is used for actuating the object moving along the slide rail in accordance with the first driving signal, the second driving signal, or the third driving signal.

Referring to FIG. 2, FIG. 2 is a schematic diagram illustrating the first driving signal, the second driving signal, and the third driving signal. The first driving signal has a first polarity and a first duty cycle T₁, as shown in FIG. 2. The second driving signal also has the first polarity and a second duty cycle T₂, as shown in FIG. 2. The third driving signal has a second polarity opposite to the first polarity and the first duty cycle T₁ plus a compensation period ΔT, as shown in FIG. 2. Furthermore, the first polarity is capable of driving the object moving along a first direction, and the second polarity is capable of driving the object moving along a second direction opposite to the first direction. When the object moves along the slide rail from the first direction to the second direction, because the duty cycle of the third driving signal (T₁+ΔT) is larger than the duty cycle of the first driving signal (T₁), the apparatus of the invention is capable of accurately adjusting the movement of the object without being influenced by the gap between any two parts. In other words, the apparatus of the invention utilizes the compensation period ΔT to make the object move with an extra distance as the object is reversed from the original direction, so as to compensate the gap between any two parts. Moreover, the compensation period ΔT can be adjusted based on different design requirement.

For example, the apparatus 10 of the invention can be applied to lift or lower the projection lens of a projector. When a user desires to adjust the projection lens upwardly, the user would keep pressing an upward button of a remote controller or the like. At this time, the processing unit 12 receives an input signal and outputting a command signal in response to the input signal. After receiving the command signal, the controlling unit 14 will output a continuously-forwarding enabling signal. After receiving the continuously-forwarding enabling signal, the driving unit 16 will output a second driving signal in response to the continuously-forwarding enabling signal. Afterward, the motor 18 will actuate the projection lens moving along the slide rail upwardly and continuously in accordance with the second driving signal until the user sets the button free. When the user desires to fine tune the projection lens upwardly for a step, he/she only needs to press the upward button once. At this time, the processing unit 12 receives an input signal and outputting a command signal in response to the input signal. After receiving the command signal, the controlling unit 14 will output a forwarding-single-step enabling signal. After receiving the forwarding-single-step enabling signal, the driving unit 16 will output a first driving signal in response to the forwarding-single-step enabling signal. Afterward, the motor 18 will actuate the projection lens moving along the slide rail upwardly with a step in accordance with the first driving signal. On the other hand, when the user desires to fine tune the projection lens form upward direction to downward direction for a step, he/she only needs to press the downward button once. At this time, the processing unit 12 receives an input signal and outputting a command signal in response to the input signal. After receiving the command signal, the controlling unit 14 will output a reversing-single-step enabling signal. After receiving the reversing-single-step enabling signal, the driving unit 16 will output a third driving signal in response to the reversing-single-step enabling signal. Afterward, the motor 18 will actuate the projection lens moving along the slide rail downwardly with a step in accordance with the third driving signal. It should be noticed that before the apparatus of the invention is applied to the projector, when the user desires to fine tune the projection lens form upward direction to downward direction for a step, the user always needs to press the button again and again to compensate the gap between any two parts, and then he/she can fine tune the projection lens by a step finally. In other words, the first press or other presses for actuating the motor by the user is used to compensate the gap between any two parts.

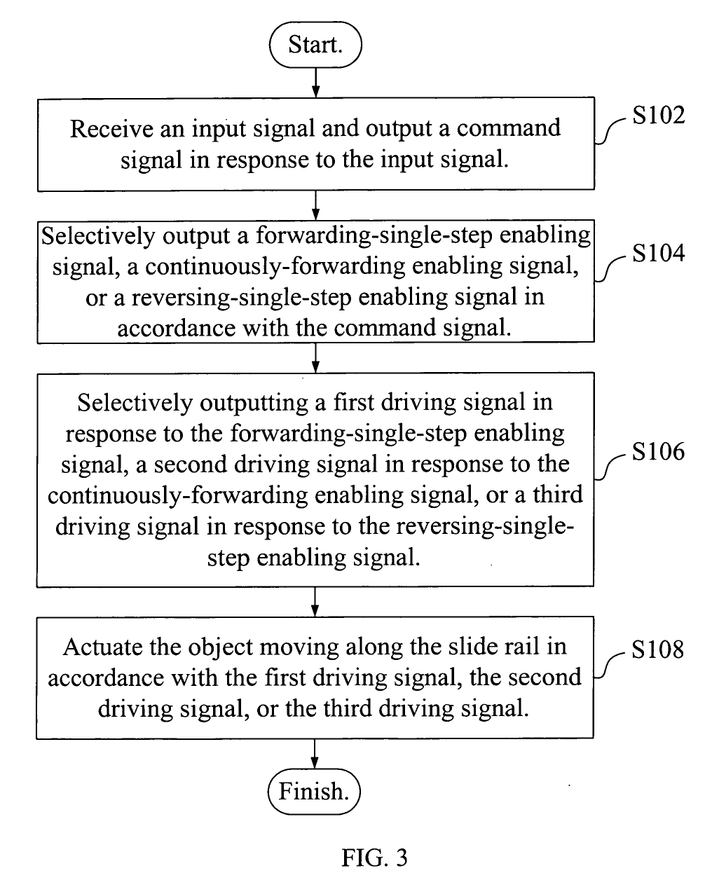

Referring to FIG. 3, FIG. 3 is a flowchart showing the method for actuating the object according to the first preferred embodiment of the invention. The method of the invention is used for actuating the object movably mounted on the slide rail. According to the above-mentioned first preferred embodiment, the method of the invention comprises the following steps. At start, step S102 is performed to receive an input signal and output a command signal in response to the input signal. Afterward, step S104 is performed to selectively output a forwarding-single-step enabling signal, a continuously-forwarding enabling signal, or a reversing-single-step enabling signal in accordance with the command signal. Step S106 is then performed to selectively outputting a first driving signal in response to the forwarding-single-step enabling signal, a second driving signal in response to the continuously-forwarding enabling signal, or a third driving signal in response to the reversing-single-step enabling signal. The first driving signal has a first polarity and a first duty cycle, the second driving signal has the first polarity and a second duty cycle, and the third driving signal has a second polarity opposite to the first polarity and the first duty cycle plus a compensation period. Step S108 is then performed to actuate the object moving along the slide rail in accordance with the first driving signal, the second driving signal, or the third driving signal.

Compared to the prior art, when the object moves along the slide rail from the first direction to the second direction, because the duty cycle of the third driving signal is larger than the duty cycle of the first driving signal, the apparatus of the invention is capable of accurately adjusting the movement of the object without being influenced by the gap between any two parts.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An apparatus for actuating an object movably mounted on a slide rail, the apparatus comprising:
a processing unit for receiving an input signal and outputting a command signal in response to the input signal;
a controlling unit, coupled to an output of the processing unit, for selectively outputting a forwarding-single-step enabling signal, a continuously-forwarding enabling signal, or a reversing-single-step enabling signal in accordance with the command signal;
a driving unit, coupled to an output of the controlling unit, for selectively outputting a first driving signal with a first polarity and a first duty cycle in response to the forwarding-single-step enabling signal, a second driving signal with the first polarity and a second duty cycle in response to the continuously-forwarding enabling signal, or a third driving signal with a second polarity opposite to the first polarity and the first duty cycle plus a compensation period in response to the reversing-single-step enabling signal; and
a motor, coupled to an output of the driving unit and operatively connected to the object, for actuating the object moving along the slide rail in accordance with the first driving signal, the second driving signal, or the third driving signal.

2. The apparatus of claim 1, wherein the object is a projection lens of a projector, and the slide rail is disposed in the projector.

3. The apparatus of claim 1, wherein the driving unit is an integrated circuit.

4. The apparatus of claim 1, wherein the first polarity is capable of driving the object moving along a first direction, and the second polarity is capable of driving the object moving along a second direction opposite to the first direction.

5. The apparatus of claim 1, wherein the first driving signal, the second driving signal, or the third driving signal is a voltage signal, respectively.

6. A method for actuating an object movably mounted on a slide rail, the method comprising steps of:
(a) receiving an input signal and outputting a command signal in response to the input signal;
(b) selectively outputting a forwarding-single-step enabling signal, a continuously-forwarding enabling signal, or a reversing-single-step enabling signal in accordance with the command signal;
(c) selectively outputting a first driving signal with a first polarity and a first duty cycle in response to the forwarding-single-step enabling signal, a second driving signal with the first polarity and a second duty cycle in response to the continuously-forwarding enabling signal, or a third driving signal with a second polarity opposite to the first polarity and the first duty cycle plus a compensation period in response to the reversing-single-step enabling signal; and
(d) actuating the object moving along the slide rail in accordance with the first driving signal, the second driving signal, or the third driving signal.

7. The method of claim 6, wherein the object is a projection lens of a projector, and the slide rail is disposed in the projector.

8. The method of claim 6, wherein the first polarity in step (c) is capable of driving the object moving along a first direction, and the second polarity in step (c) is capable of driving the object moving along a second direction opposite to the first direction.

9. The method of claim 6, wherein the first driving signal, the second driving signal, or the third driving signal in step (c) is selectively outputted by an integrated circuit.

10. The method of claim 6, wherein the first driving signal, the second driving signal, or the third driving signal is a voltage signal, respectively.
